(19) United States
(12) Patent Application Publication
(10) Pub. No.: US 2025/0061328 A1
(43) Pub. Date: Feb. 20, 2025

(54) PERFORMING CLASSIFICATION USING POST-HOC AUGMENTATION

(71) Applicant: Google LLC, Mountain View, CA (US)

(72) Inventors: Mariano Ruben Schain, Tel Aviv (IL); Elad Eban, Sunnyvale, CA (US)

(21) Appl. No.: 18/723,243

(22) PCT Filed: Dec. 15, 2022
(86) PCT No.: PCT/US2022/053051

§ 371 Date: Jun. 21, 2024

Related U.S. Application Data
(60) Provisional application No. 63/293,604, filed on Dec. 23, 2021.

(51) Int. Cl. G06N 3/08; G06N 3/0455

(52) U.S. Cl. CPC G06N 3/08; G06N 3/0455

(57) ABSTRACT

Methods, systems, and apparatus, including computer programs encoded on computer storage media, for processing network inputs by applying augmentations to internal representations of the network inputs.

### CROSS-REFERENCE TO RELATED APPLICATIONS

This application claims the benefit of priority to U.S. Provisional Application Ser. No. 63/293,604, filed Dec. 23, 2021, the entirety of which is incorporated herein by reference.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that process a network input using a neural network that includes a neural network body and a neural network head.

In particular, after processing the network input using the neural network body to generate an internal representation of the network input, the system generates one or more augmented representations from the internal representation and then processes each of the augmented representations using the neural network head to generate a respective classification output for each augmented representation. The system then combines at least the respective classification outputs for each of the augmented representations to generate a final classification output for the network input.

Particular embodiments of the subject matter described in this specification can be implemented so as to realize one or more of the following advantages.

In many applications, the performance of a trained classifier given an input may be improved by using data augmentation, i.e., by using the trained classifier to classify multiple perturbed variations (through a random transformation) of the given input, and consolidating the multiple results to a single prediction. However, this requires processing multiple different perturbed variations through the trained classifier, i.e., performing multiple forward passes through the entire trained classifier to generate a classification output for a single input. This limits the applicability of this augmentation technique, particularly in resource-constrained or time-constrained settings, e.g., when the classifier is deployed on an edge device, e.g., a mobile phone, a smart speaker, or other device with limited computational resources or when the classifier is deployed on an autonomous vehicle, a robotic agent, or another environment where low-latency classifications are critical.

The techniques described in this specification, on the other hand, apply transformations to the internal features of an input. That is, rather than augmenting the network input, the system only augments an internal representation of the network input generated by a “neural network body” of the neural network. This is referred to as “post-hoc” augmentation.

Thus, only a single pass through the computationally expensive “body” of the trained classifier is required and performance is significantly improved by only performing additional forward passes through the relatively inexpensive “head” of the trained classifier. Thus, the described techniques allow the performance improvements resulting from data augmentation to be realized in resource-constrained and time-constrained settings while eliminating the large majority of the computational overhead associated with conventional augmentation techniques. That is, the described techniques can allow a system to realize the performance improvements associated with augmentation with minimal computational overhead relative to conventional augmentation techniques.

Moreover, conventional techniques struggle to account for the fact that different inference devices, i.e., different devices on which different instances of a given model will be deployed for performing inference after the model has been trained, have different amounts of available compute. In order to support a vast number of devices, the weakest supported devices will impose unnecessary quality constraints on stronger devices. That is, if only a single model is maintained after training, the model must be able to be deployed on a “weak” device, i.e., a device with relatively limited memory constraints and computational power, meaning that the model does not leverage the additional performance gains that could be achieved by leveraging the extra compute available on “strong” devices. Therefore, current solutions need to choose between supporting a set of multiple models that includes different models for different devices (which scales poorly and is very costly) or maintaining a single model, but under-utilizing the capabilities of stronger hardware.

The use of the described augmentation techniques allow the use of an adaptive scheme in which a given model can be deployed on a weak device, i.e., a device with very limited computational resources, as is, while when deployed on a stronger device it can be combined with the described augmentation engine that will enhance its accuracy while keeping resource utilization under control. As a result, all devices can share the same baseline model while performance and quality are device-specific.

In other words, without using this scheme, one could train custom models per device or platform. However the training, validation, calibration and maintenance cost of a model per platform is prohibitive and scales with the number of different platforms. By using the described augmentation engine, a single model is trained and only a respective augmentation engine needs to be calibrated for each inference device, which has a dramatically lower systems-maintenance cost. Compared to having a single model, which will be either too costly (slow) on weak devices, or would have lower quality than possible on stronger platforms, the described scheme can consume different amounts of resources on different devices and can therefore maximize the performance of the neural network given the available computational resources on a given device.

Furthermore, each augmented representation of the input may be processed in parallel by one or more processors executing the neural network head (or multiple copies of it), which may increase the speed at which inference is performed. In other words, by processing the augmented representations in parallel using the neural network head, the system can leverage parallelization to provide the performance benefits described above with minimal impact of latency, which, as described above, is critical in many real-world situations.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows the training of the augmentation engine.

FIG. 3 is a flow diagram of an example process for processing a network input to generate a final classification output for the network input.

FIG. 4 is a flow diagram of an example process for training the augmentation engine.

Like reference numbers and designations in the various drawings indicate like elements.

### DETAILED DESCRIPTION

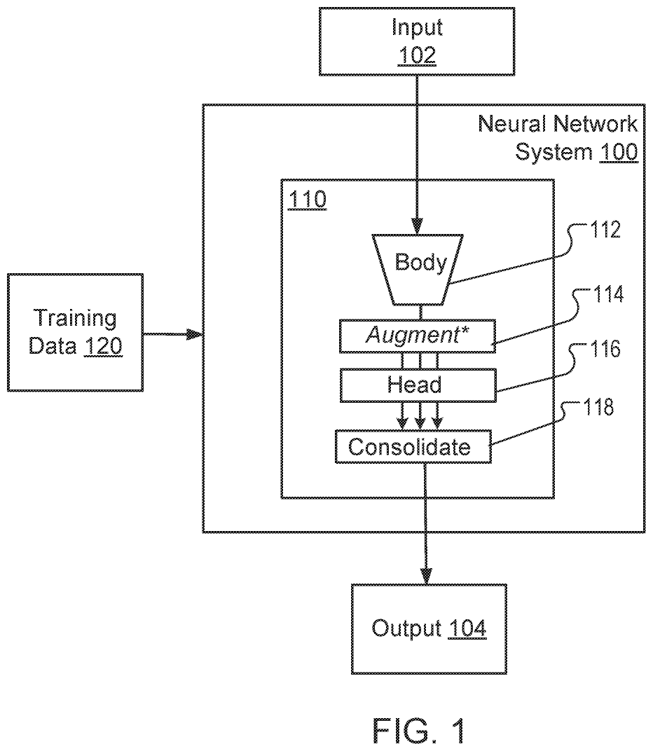

FIG. 1 shows an example neural network system 100. The neural network system 100 is an example of a system implemented as computer programs on one or more computers in one or more locations, in which the systems, components, and techniques described below can be implemented.

The neural network system 100 uses a neural network 110 to perform a machine learning task, i.e., to process network inputs 102 to generate final classification outputs 104 for the machine learning task.

The neural network 110 can be configured through training to perform any kind of classification machine learning task, i.e., can be configured to receive any kind of digital data input and to generate any kind of classification output based on the input. A classification output is one that includes one or more score distributions over a set of classes for each input.

In some cases, the neural network is a neural network that is configured to perform a computer vision task, i.e., receive a network input that includes one or more images and to process the network input to generate a network output for the input image.

The one or more input images can be any appropriate type of image. For example, the image can be a two-dimensional image, e.g., a two-dimensional image that has multiple channels (e.g., an RGB image). As another example, the image can be a hyperspectral image that represents a continuous spectrum of wavelengths, e.g., by identifying, for each pixel in the image, a distribution over the spectrum. As another example, the image can be a point cloud that includes multiple points, where each point has a respective coordinate, e.g., in a three-dimensional or a higher-dimensional coordinate space: as a particular example, the image can be a point cloud generated by a LIDAR sensor. As another example, the image can be a medical image generated by a medical imaging device: as particular examples, the image can be a computer tomography (CT) image, a magnetic resonance imaging (MRI) image, an ultrasound image, an X-ray image, a mammogram image, a fluoroscopy image, or a positron-emission tomography (PET) image.

In some cases the one or more images are static over time, i.e., there is a single set of one or more images that is provided as input to the neural network 110.

In some other cases, the one or more images change over time. As a particular example, the network input can be a video that includes a respective image at each of multiple time steps.

For example, the task may be image classification, and the output generated by the neural network for a given image may be scores for each of a set of object categories, with each score representing an estimated likelihood that the image contains an image of an object belonging to the category.

As yet another example, the task can be image segmentation and the output generated by the neural network can include, for each pixel of each input image, scores for each of a set of object categories, with each score representing an estimated likelihood that the portion of the image depicted at that pixel is part of an image of an object belonging to the category.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, the task may be an audio processing task. For example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

Generally, the neural network 110 has an architecture that includes a neural network body 112 and a neural network head 116.

The neural network body 112 includes the initial layers of the neural network 110. That is, the body 112 receives the network input 102 and processes the network input 102 to generate an internal representation of the network input 102.

When the described augmentation techniques are not used, the neural network head 116 receives the internal representation of the network input 102 and processes the internal representation to generate a classification output 104 for the network input.

Generally, the computation performed by the body 112 to generate the internal representation of the network input 102 is significantly more computationally expensive than the computation performed by the head 116 to generate the classification output 104. In particular, the body 112 can include more parameters than the head 116, a larger number of layers than the head 116, or both, and/or a more complex network structure than the head 116.

For example, when the neural network 110 is a convolutional neural network, the body 112 can include an initial set of layers that includes multiple convolutional layers and that map the network input to an internal representation that has a reduced dimensionality relative to the network input. That is, the internal representation has fewer numerical values than the network input. For example, if the network input is an image, the internal representation can be a vector or a tensor that has a smaller dimensionality than the image. The initial set of layers can optionally include additional layers other than convolutional layers, e.g., pooling layers, normalization layers, and so on.

The head 116 can include a set of one or more neural network layers, e.g., one or more fully-connected layers followed by a softmax layer, that process the internal representation to generate the classification output for the network input.

As another example, when the neural network 110 is a Transformer neural network, the body 112 can include an initial set of layers that includes multiple self-attention layers that operate on embeddings of each input in a sequence of inputs that represents the network input, e.g., embeddings of patches of an input image or embeddings of text tokens representing an input text sequence, and that map the network input to a sequence of updated embeddings. The initial set of layers can optionally include additional layers other than self-attention layers, e.g., fully-connected layers, normalization layers, and so on.

The head 116 can include a set of one or more neural network layers, e.g., one or more fully-connected layers followed by a softmax layer, that process one or more of the updated embeddings or an aggregated embedding generated from the updated embeddings, e.g., by applying a pooling operation to the updated embeddings, to generate the classification output for the network input. That, is, the “internal representation” can be the aggregated embedding or can be the one or more updated embeddings that are processed by the head 116. As a particular example, the head 116 can process a designated one of the updated embeddings or the aggregated embedding through one or more fully-connected layers followed by a softmax layer or can process each updated embedding separately through one or more fully-connected layers followed by a softmax layer to generate a respective portion of the classification output.

In order to apply data augmentation in a computationally-efficient manner, the system 100 includes an augmentation engine 114.

The augmentation engine 114 is configured to generate, from the internal representation, a plurality of augmented representations. Each augmented representation has the same dimensionality as the internal representation, i.e., is from the same representation space and has the same total number of numerical values, but has different values from the internal representation.

That is, the augmentation engine 114 is configured to apply multiple different transformations to the internal representation to generate, for each transformation, a corresponding augmented representation.

Because the engine 114 operates on the internal representation rather than on the network input, the engine 114 can be applied in a computationally-efficient manner, i.e., because only one network input needs to be processed by the computationally expensive body 112 to generate the multiple augmented representations.

More specifically, the augmentation engine 114 has parameters (“augmentation parameters”) that are learned through training and generates the augmented representations in accordance with the parameters.

As one example, the augmentation engine 114 can generate parameters of a probability distribution over possible representations, i.e., over the internal representation space, by processing the internal representation in accordance with the augmentation parameters. As a particular example, the probability distribution can be a Gaussian mixture model and the parameters can be the mean and the covariances of the Gaussian mixture model.

For example, the engine 114 can implement an estimation neural network, e.g., one that includes one or more fully-connected layers, that is configured to process the internal representation to generate the parameters.

The engine 114 can then generate the augmented representations by sampling a fixed number of representations from the probability distribution defined by the parameters that are output by the estimation neural network.

In these examples, the augmentation parameters are parameters of the estimation neural network.

As another example, the augmentation engine 114 can implement a variational auto-encoder neural network (VAE). The VAE includes an encoder neural network that processes the internal representation to generate parameters of a probability distribution over possible latent representations, i.e., over a space of latent representations that has the same dimensionality as the internal representations or a different dimensionality. The VAE also includes a decoder neural network that processes a latent representation to generate as output a representation from the internal representation space.

In this example, the engine 114 can process the internal representation using the encoder of the VAE to generate the parameters of the probability distribution over possible latent representations. The engine 114 can then sample a fixed number of latent representations from the probability distribution and then process each sampled representation using the decoder of the VAE to generate a respective augmented representation for each sampled latent representation.

In these examples, the augmentation parameters are the parameters of the encoder and the decoder of the VAE.

The system 100 then processes each augmented representation using the neural network head 116 to generate a respective initial classification output for each augmented representation. Optionally, the system 100 can also process the internal representation, i.e., the non-transformed internal representation, using the neural network head 116 to generate an initial classification output for the internal representation.

A consolidation engine 118 within the system 100 then combines the respective initial classification outputs for the augmented representations and, when generated, the initial classification output for the internal representation to generate a final classification output 104.

For example, the consolidation engine 118 can average the respective initial classification outputs to generate the final classification output 104.

In some cases, the consolidation engine 118 also computes a measure of uncertainty from the initial classification outputs, e.g., by computing the variance of the respective initial classification outputs or by computing another statistic that measures the spread of a distribution, and provides the measure of uncertainty along with the final classification output 104.

Prior to using the neural network 110 to process new network inputs, the system 100 or another training system trains the neural network 110 on training data.

Generally, the training data includes a plurality of training examples, with each training example including a training network input and a target output for the training network input. The target output is an output that should be generated by performing the machine learning task on the training network input, i.e., is the ground truth output for the machine learning task for the training network input.

The neural network 110 can be trained on the training data using any conventional supervised learning or semi-supervised learning technique to optimize any appropriate supervised learning or semi-supervised learning objective function. When semi-supervised learning is used, the training data can also include unlabeled training inputs that do not have an associated target output. For example, the training system can train the neural network to minimize a classification loss, e.g., a cross-entropy loss, on a set of labeled training data that is appropriate for the classification task. Optionally, prior to using the cross-entropy loss for the classification task, the training system can pre-train the neural network 110 on a different task, e.g., another classification task or an unsupervised learning task.

That is, the training system can train the neural network 110 using a conventional machine learning technique that does not account for the presence of the augmentation engine 114.

After training the neural network 110, the system 100 or another system also learns the parameters of the augmentation engine 114. That is, the system 100 learns the parameters that define how the internal representation is transformed in order to generate the plurality of augmented representations.

More specifically, the system 100 can learn the parameters of the augmentation engine 114 so that the transformations applied by the engine 114 generate, for a given network input, augmented representations that are statistically similar to internal representations that would be generated by the neural network body 112 for augmented network inputs that have been augmented by applying data augmentation to the given network input. That is, the system 100 can learn the parameters of the augmentation engine 114 so that the transformations applied by the engine 114 generate, for a given network input, augmented representations that appear to be drawn from a distribution of internal representations that would be generated by the neural network body 112 for augmented network inputs that have been augmented by applying data augmentation to the given network input.

Generally, the augmentation engine 114 can be trained using the original training data used to train the neural network 110 or another source of data, whether the data is labeled or unlabeled. That is, the training procedure of the engine 114 does not require the data used for the procedure to be labeled. Therefore, since the training procedure of the engine 114 does not require labeled data, the training of the engine 114 can be a cheap process both in terms of training resources required and in the amount of data needed.

This allows the engine 114 to be trained in a data center or on an edge device.

For example, the neural network 110 can be trained in a data center and then deployed on an edge device, e.g., a mobile device, a personal assistant device, or another Internet of Things (IoT) device. The engine 114 can then be trained on the edge device, e.g., on data that is specific to the edge device 114, without requiring the data used for this training to be sent to the data center or otherwise transmitted off-device.

This type of training can have numerous advantages. As one example, the engine 114 can be re-trained on live traffic data periodically, without disrupting the more complicated and stable underlying model (body 112+head 116). This data can be transient and does not need to be stored. Thus, the performance of the system 100 will not degrade even if the distribution of training inputs changes after the neural network 110 and the engine 114 have been initially trained.

As another example, this allows the performance of the neural network 110 to be tailored to user-specific data. Consider for instance two users who have inputs that come from disjoint distributions (for example, one user can be mainly taking pictures of animals, while the other of buildings). The training of the engine 114 can be used to account for this change without disturbing the complex, generic neural network 110 and to provide quality gains from personalization, while maintaining the robustness and ease of deployment of a generic model.

Moreover, because the engine 114 can be trained on-device, the data used to train the engine 114 does not need to be transmitted off-device, mitigating security risks.

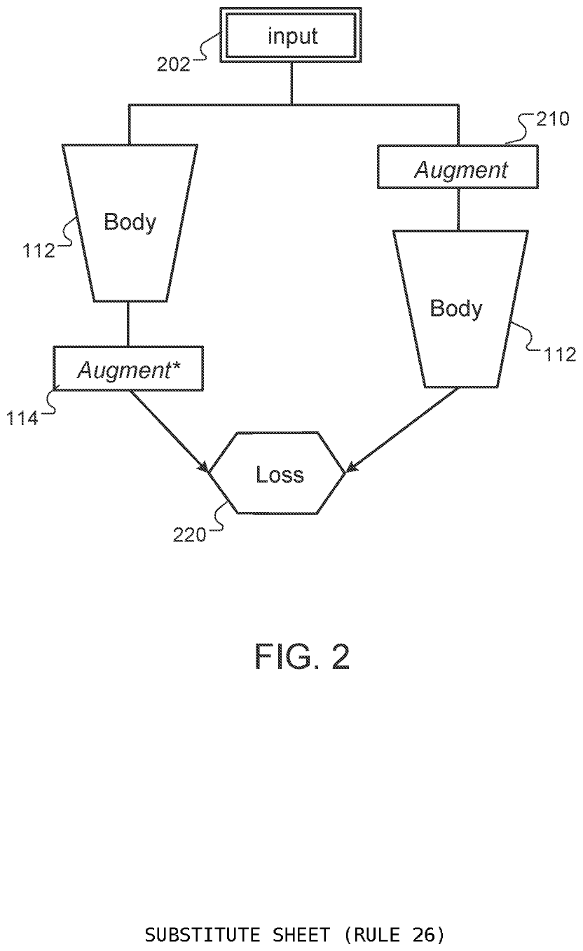

This learning is described below with reference to FIG. 2.

FIG. 2 shows the training of the augmentation engine 114, i.e., illustrates how the parameters of the augmentation engine 114 are learned after the neural network 110 has been trained. The training shown in FIG. 2 can be performed by a training system, e.g., the system 100 or another system of one or more computers in one or more locations.

FIG. 2 illustrates the processing of a single training input 202. More generally, however, the system can perform the steps illustrated in FIG. 2 for a batch of one or more training inputs 202 each time that the parameters of the augmentation engine 114 are updated.

As shown in FIG. 2, the training system processes the training input 202 using the neural network body 112 to generate an internal representation of the training input 202.

The training system then uses the augmentation engine 114 to generate, from the internal representation, one or more augmented representations of the training input 202, e.g., as described above, in accordance with the current augmentation parameters.

The training system also applies one or more data augmentations 210 to the training input 202 to generate one or more augmented training inputs. In particular, the system 100 can generate each of the one or more augmented training inputs by applying a data augmentation policy to the training input 202.

The data augmentation policy can apply one or more augmentations from a set of augmentations that is appropriate for the type of data that is included in the network input. For example, the augmentation policy for images can include rotations, crops, noise, brightness and contrast modifications, and so on. In the case of audio data, the set of augmentations can include background noise, pitch distortions, time distortions, echo and so on.

As a particular example, to generate a given augmented input, the data augmentation policy can select, e.g., randomly, one or more augmentations from the set of augmentations and apply the selected augmentation(s) to the training input to generate the given augmented input.

That is, unlike the inference process described above with reference to FIG. 1, during training the system performs augmentation both in the input space and in the internal representation space for the same training input.

The system then processes each augmented training input using the neural network body 112 to generate a respective internal representation for each augmented training input.

The system then computes gradients with respect to the parameters of the engine 114 of an augmentation loss 220 that measures a difference between the augmented representations of the training input and the internal representations for the augmented training inputs.

The system then updates the augmentation engine parameters based on the gradients, e.g., by applying an optimizer to the parameter and the gradients. The optimizer can be any appropriate machine learning optimizer, e.g., stochastic gradient descent, Adam, or Adafactor.

Generally, for each training input in the batch, the augmentation loss 220 encourages the augmented representations of the training input to be similar to the internal representations for the augmented training inputs that are generated from the training input.

More specifically, when the augmentation engine 114 generates parameters of a probability distribution, the augmentation loss measures, for each augmented input, the probability assigned to the internal representation of the augmented input by the probability distribution. For example, the augmentation loss 220 can be a negative log likelihood loss that measures, for each training input in the batch and for each of the one or more augmented inputs generated for the training input, the negative of the log of the probability assigned to the internal representation of the augmented input in the probability distribution defined by processing the internal representation of the training input using the augmentation engine 114.

When the augmentation engine 114 implements a VAE, the augmentation loss measures the similarity between each augmented representation and a corresponding internal representation for a corresponding augmented input. The system can use any appropriate VAE training loss that uses, as the target output for a given augmented representation for a given training input, one of the internal representations for one of the augmented inputs generated from the given training input. For example, the VAE training loss can include, for each given augmentation representation, a reconstruction loss term that measures errors between the given augmented representation and the internal representation of the corresponding augmented input and a regularization term, e.g., a KL divergence term, for the probability distribution over the latent space generated by the encoder of the VAE.

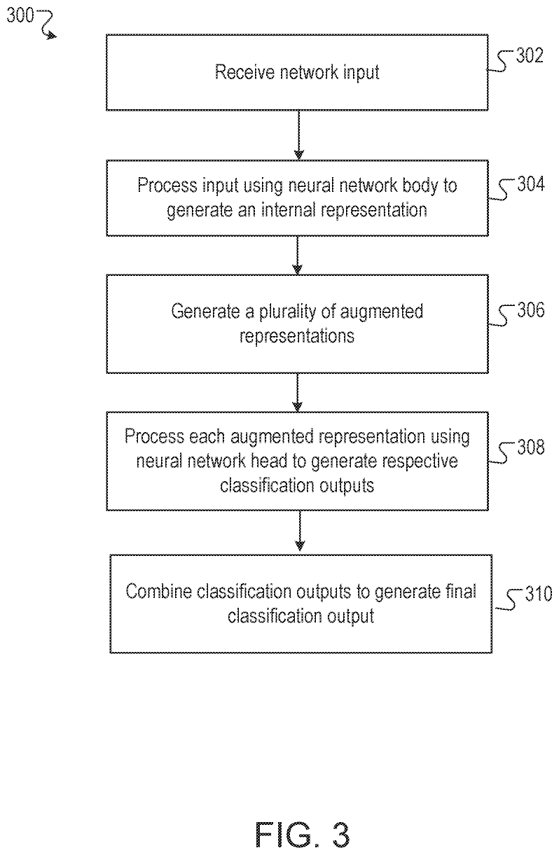

FIG. 3 is a flow diagram of an example process 300 for processing a network input using a neural network to generate a final classification output. For convenience, the process 300 will be described as being performed by a system of one or more computers located in one or more locations. For example, a neural network system, e.g., the neural network system 100 of FIG. 1, appropriately programmed, can perform the process 300.

The system receives a network input (step 302).

The system processes the network input using the neural network body of the neural network to generate an internal representation of the network input (step 304).

The system generates a plurality of augmented representations from the network input (step 306).

In some implementations, the number of augmented representations that are generated is fixed, i.e., the system generates the same number of augmented representations for each network input.

In some other implementations, the number of augmented representations can vary based on the current resource utilization on the device(s) on which the neural network is deployed. That is, the system can maintain data specifying a total amount of computational resources that are available on the device(s) for processing network inputs, e.g., in terms of number of operations. The system can then determine, for each network input, to generate the maximum number of augmented representations that will result in the total number of operations not exceeding the total amount of available resources.

As a particular example, the number of network inputs that need to be classified at any given time may vary while the total available computational resources for classifying network inputs on the device(s) on which the neural network is deployed at any given time may be fixed to a computation capacity of c operations per second. Then, at any given time, the system can determine how augmented representations to generate based on how many network inputs need to be classified at the given time, i.e., to generate the maximum number of augmented representations (and, therefore, to maximize performance) that would not exceed the total available computational resources.

As a particular example of this, at any given time t, the system can determine to generate a number of augmented representations for each network input that needs to be classified at time t as follows:

$$k ( t ) = \frac{\frac{c}{q ( t )} - b}{a + h} ,$$

where q(t) is the number of network inputs that need to be classified at time t, b is the number of computation operations required for applying the body, a is the number of computation operations required for applying the augmentation engine to generate a single augmented input, and h is the number of computation operations required for applying the head, and k(t) is rounded down to the nearest integer to determine the number of augmented representations.

The system generates the plurality of augmented representations by processing the network input using an augmentation engine. More specifically, the augmentation engine has parameters (“augmentation parameters”) that are learned through training and generates the augmented representations in accordance with the parameters.

As one example, the augmentation engine can generate parameters of a probability distribution over possible representations, i.e., over the internal representation space, by processing the internal representation in accordance with the augmentation parameters. As a particular example, the probability distribution can be a Gaussian mixture model and the parameters can be the mean and the covariances of the Gaussian mixture model.

For example, the engine can implement an estimation neural network, e.g., one that includes one or more fully-connected layers, that is configured to process the internal representation to generate the parameters.

The engine can then generate the augmented representations by sampling the determined number of representations from the probability distribution.

In these examples, the augmentation parameters are parameters of the estimation neural network.

As another example, the augmentation engine can implement a variational auto-encoder neural network (VAE). The VAE includes an encoder neural network that processes the internal representation to generate parameters of a probability distribution over possible latent representations, i.e., over a space of latent representations that has the same dimensionality as the internal representations or a different dimensionality. The VAE also includes a decoder neural network that processes a latent representation to generate as output a representation from the internal representation space.

In this example, the engine can process the internal representation using the encoder of the VAE to generate the parameters of the probability distribution over possible latent representations. The engine can then sample the determined number of latent representations from the probability distribution and then process each sampled representation using the decoder of the VAE to generate a respective augmented representation for each sampled latent representation.

In these examples, the augmentation parameters are the parameters of the encoder and the decoder of the VAE.

The system processes each augmented representation using the neural network head of the neural network to generate respective initial classification outputs for each of the augmented representations (step 308). Optionally, the system also processes the internal representation using the neural network head of the neural network to generate a respective initial classification output for the internal representation. In some implementations, the system processes the augmented representations (and, when done, the initial representation) using the neural network head in parallel to generate the respective initial classification outputs. That is, because the augmented representations and the initial representation are processed through the head independently of one another, the system can leverage this independence to process the augmented representations and, optionally, the initial representation in parallel on the device(s) on which the neural network is deployed.

The system combines, e.g., averages, the respective initial classification outputs to generate a final classification output for the network input (step 310). As described above, the system can optionally also compute a measure of uncertainty from the initial classification outputs, e.g., by computing the variance of the respective initial classification outputs or by computing another statistic that measures the spread of a distribution, and provides the measure of uncertainty along with the final classification output.

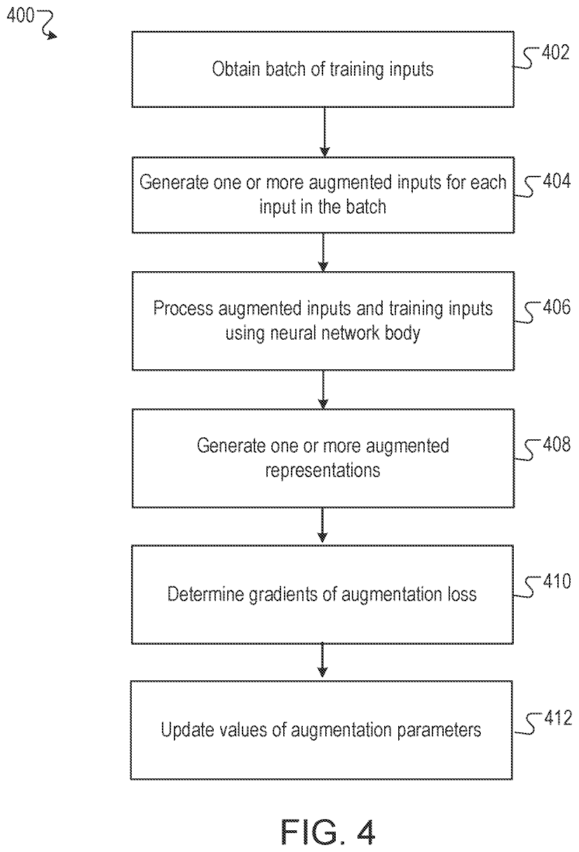

FIG. 4 is a flow diagram of an example process 400 for training the augmentation engine. For convenience, the process 400 will be described as being performed by a system of one or more computers located in one or more locations. For example, a neural network system, e.g., the neural network system 100 of FIG. 1, appropriately programmed, can perform the process 400.

The system can repeatedly perform iterations the process 400 for multiple batches of training inputs. In particular, the system can perform iterations of the process 400 until a termination criterion is satisfied, e.g., the parameters of the engine have converged, a compute budget for the training has been exhausted, a user input is received terminating the training, and so on.

More specifically, the system can repeatedly perform the process 400 after the neural network has been trained, i.e., without adjusting the parameters of the neural network head or the neural network body.

The training inputs that are used can be from the same set of training data that was used to train the neural network or can be a different set of training inputs.

The system obtains a batch of one or more training inputs (step 402). As described above, the system does not need to make use of any target outputs for any of the training inputs.

For each training input in the batch, the system generates one or more augmented inputs by applying data augmentation to the training input (step 404).

For each training input in the batch, the system processes the augmented input(s) for the training input and the training input using the neural network body to generate a respective internal representation for each augmented input and for the training input (step 406).

For each training input in the batch, the system generates one or more augmented representations for the training input (step 408) by processing the training input using the augmentation engine and in accordance with current values of the augmentation parameters of the augmentation engine.

The system determines gradients with respect to the augmentation parameters of an augmentation loss that measures, for each training input in the batch, the similarity between the one or more augmented representations for the training input and the internal representations for the one or more augmented inputs generated from the training input (step 410).

The system can compute the gradients of the loss using a conventional technique, e.g., backpropagation.

The system updates the current values of the augmentation parameters from the gradients (step 412). In particular, the system applies an optimizer, e.g., SGD, Adam, or rmsProp, to the gradients to update the current values of the parameters, i.e., to generate updated values of the parameters for use in the next iteration of the process 400.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a network input; and
generating a final classification output for the network input using a neural network that comprises a neural network body and a neural network head, the generating comprising:
processing the network input using the neural network body to generate an internal representation of the network input;
generating, from the internal representation of the network input, a plurality of augmented representations of the internal representation;
processing each augmented representation using the neural network head to generate a respective initial classification output for each augmented representation; and
combining at least the respective initial classification outputs for the augmented representations to generate the final classification output for the network input.

2. The method of claim 1, wherein the generating further comprises:
processing the internal representation using the neural network head to generate a respective initial classification output for the internal representation, wherein combining at least the respective initial classification outputs for the augmented representations to generate the final classification output for the network input comprises:
combining the respective initial classification outputs for the augmented representations and the respective initial classification output for the internal representation to generate the final classification output for the network input.

3. The method of claim 2, wherein combining the respective initial classification outputs for the augmented representations and the respective initial classification output for the internal representation to generate the final classification output for the network input comprises averaging the respective initial classification outputs for the augmented representations and the respective initial classification output for the internal representation.

4. The method of claim 1, wherein combining at least the respective initial classification outputs for the augmented representations a to generate the final classification output for the network input comprises averaging the respective initial classification outputs for the augmented representations.

5. The method of claim 1, wherein generating, from the internal representation of the network input, a plurality of augmented representations of the internal representation comprises:
processing the internal representation using an augmentation engine having augmentation parameters that have been learned through training to generate the plurality of augmented representations.

6. The method of claim 5, wherein processing the internal representation using an augmentation engine having augmentation parameters that have been learned through training to generate the plurality of augmented representations comprises:
processing the internal representation using the augmentation engine and in accordance with the augmentation parameters to generate parameters of a probability distribution over possible augmented representations; and
sampling the plurality of augmented representations from the probability distribution.

7. The method of claim 5, wherein processing the internal representation using an augmentation engine having augmentation parameters that have been learned through training to generate the plurality of augmented representations comprises:
processing the internal representation using an encoder neural network to generate parameters of a probability distribution over possible latent representations;
sampling a plurality of latent representations from the probability distribution; and
processing each latent representation using a decoder neural network to generate a respective augmented representation.

8. The method of claim 7, wherein the encoder neural network and the decoder neural network have been trained jointly as a variational auto-encoder (VAE).

9. The method of claim 5, wherein the augmentation engine has been trained to minimize a loss that encourages, for a given training input, the training engine to generate augmented representations of the given training network input that are statistically similar to internal representations that would be generated by the neural network body for augmented inputs that have been augmented by applying data augmentation to the given training input.

10. The method of claim 9, wherein the augmentation engine has been trained after training of the neural network and while holding parameters of the neural network body fixed.

11. The method of claim 10, wherein the augmentation engine has been trained using training inputs that are different from training inputs in training data used to train the neural network.

12. The method of claim 1, wherein processing each augmented representation using the neural network head to generate a respective initial classification output for each augmented representation comprises processing the augmented representations in parallel.

13. (canceled)

14. One or non-transitory more computer-readable storage media storing instructions that when executed by one or more computers cause the one or more computers to perform operations comprising:
obtaining a network input; and
generating a final classification output for the network input using a neural network that comprises a neural network body and a neural network head, the generating comprising:
processing the network input using the neural network body to generate an internal representation of the network input;
generating, from the internal representation of the network input, a plurality of augmented representations of the internal representation;
processing each augmented representation using the neural network head to generate a respective initial classification output for each augmented representation; and
combining at least the respective initial classification outputs for the augmented representations to generate the final classification output for the network input.

15. A system comprising one or more computers and one or more storage devices storing instructions that when executed by one or more computers cause the one or more computers to perform operations comprising:
obtaining a network input; and
generating a final classification output for the network input using a neural network that comprises a neural network body and a neural network head, the generating comprising:
processing the network input using the neural network body to generate an internal representation of the network input;
generating, from the internal representation of the network input, a plurality of augmented representations of the internal representation;
processing each augmented representation using the neural network head to generate a respective initial classification output for each augmented representation; and
combining at least the respective initial classification outputs for the augmented representations to generate the final classification output for the network input.

16. The system of claim 15, wherein the generating further comprises:
processing the internal representation using the neural network head to generate a respective initial classification output for the internal representation, wherein combining at least the respective initial classification outputs for the augmented representations to generate the final classification output for the network input comprises:
combining the respective initial classification outputs for the augmented representations and the respective initial classification output for the internal representation to generate the final classification output for the network input.

17. The system of claim 16, wherein combining the respective initial classification outputs for the augmented representations and the respective initial classification output for the internal representation to generate the final classification output for the network input comprises averaging the respective initial classification outputs for the augmented representations and the respective initial classification output for the internal representation.

18. The system of claim 15, wherein combining at least the respective initial classification outputs for the augmented representations a to generate the final classification output for the network input comprises averaging the respective initial classification outputs for the augmented representations.

19. The system of claim 15, wherein generating, from the internal representation of the network input, a plurality of augmented representations of the internal representation comprises:
processing the internal representation using an augmentation engine having augmentation parameters that have been learned through training to generate the plurality of augmented representations.

20. The system of claim 19, wherein processing the internal representation using an augmentation engine having augmentation parameters that have been learned through training to generate the plurality of augmented representations comprises:
processing the internal representation using the augmentation engine and in accordance with the augmentation parameters to generate parameters of a probability distribution over possible augmented representations; and
sampling the plurality of augmented representations from the probability distribution.

21. The system of claim 19, wherein processing the internal representation using an augmentation engine having augmentation parameters that have been learned through training to generate the plurality of augmented representations comprises:
processing the internal representation using an encoder neural network to generate parameters of a probability distribution over possible latent representations;
sampling a plurality of latent representations from the probability distribution; and
processing each latent representation using a decoder neural network to generate a respective augmented representation.
